(19) United States
(12) Patent Application Publication
(10) Pub. No.: US 2025/0370865 A1
(43) Pub. Date: Dec. 4, 2025

(54) COMMAND ADDRESS PARITY CHECK USING REPURPOSING

(71) Applicant: Micron Technology, Inc., Boise, ID (US)

(72) Inventors: Scott E. SCHAEFER, Boise, ID (US); Hiroki TAKAHASHI, Sagamihara-shi (JP)

(21) Appl. No.: 19/170,778

(22) Filed: Apr. 4, 2025

Related U.S. Application Data
(60) Provisional application No. 63/653,466, filed on May 30, 2024.

(51) Int. Cl. G06F 11/10; G06F 9/30; G06F 13/16

(52) U.S. Cl. CPC G06F 11/1068; G06F 9/30189; G06F 13/1689

(57) ABSTRACT

In some implementations, a memory device may receive a mode register command that configures a parameter in a mode register of the memory device. The memory device may receive a set of command bits that indicates a command, where configuration of the parameter in the mode register frees a switchable parameter bit, of the set of command bits, that otherwise is used to configure the parameter, and where the switchable parameter bit is used as a parity bit relating to remaining bits of the set of command bits. The memory device may perform a parity check using the switchable parameter bit that is used as the parity bit.

### CROSS-REFERENCE TO RELATED APPLICATION

This patent application claims priority to U.S. Provisional Patent Application No. 63/653,466, filed on May 30, 2024, entitled “COMMAND ADDRESS PARITY CHECK USING REPURPOSING,” and assigned to the assignee hereof. The disclosure of the prior application is considered part of and is incorporated by reference into this patent application.

### TECHNICAL FIELD

The present disclosure generally relates to memory devices, memory device operations, and, for example, to a command address parity check using repurposing.

### BACKGROUND

Memory devices are widely used to store information for various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of a command address parity check using repurposing.

FIGS. 2A-2B show a table indicating command definitions for memory.

FIG. 3 is a diagram of an example of a command address parity check using repurposing.

FIG. 4 is a flowchart of an example method associated with a command address parity check using repurposing.

FIG. 5 is a flowchart of an example method associated with a command address parity check using repurposing.

### DETAILED DESCRIPTION

Memory devices may be components in various computing systems, including servers, personal computers, and mobile devices. The performance and reliability of these systems is linked to the capabilities of the memory devices that are utilized. As system data rates become faster to meet the demands of higher-speed applications, the commands and addresses signaled to a memory device must not only be fast but also error-free. Rapid signaling, however, introduces a higher potential for error.

Command address (CA) parity checking may be used to verify the validity of information signaled to a memory device. However, memory devices (e.g., DRAM devices), such as those conforming to low power (LP) standards, may have limited provisions for effective error checking on command and address inputs. For example, memory devices may lack pins dedicated for CA parity.

Some implementations described herein achieve optimized command and address signaling by repurposing existing command pins of a memory device for parity checking. For example, the memory device may receive a set of command bits, via the set of command pins, where one or more bits from the set of command bits may be repurposed as parity bits to enhance error checking. The parity bits may relate to remaining bits of the set of command bits, allowing the memory device to use these repurposed parity bits to perform parity checks on command and address information received in those remaining bits. In scenarios where a command definition, for a command to be signaled on the command pins, includes one or more “reserved for future use” (RFU) bits and/or one or more switchable parameter bits, these bits can be repurposed as parity bits. For example, switchable parameter bits can be dynamically configured via a mode register setting, thereby enabling the use of these switchable parameter bits as parity bits when needed.

This adaptive configuration facilitates improved and efficient parity checking within the design constraints of existing memory device pin layouts. Accordingly, dedicated CA parity pins, which add additional bulk and complexity, are not needed. By repurposing multiple command bits as parity bits, diagnostic coverage (DC) may be 78.6% or higher, thereby bolstering the error detection capabilities of the memory device and sustaining data integrity at increasingly higher data rates.

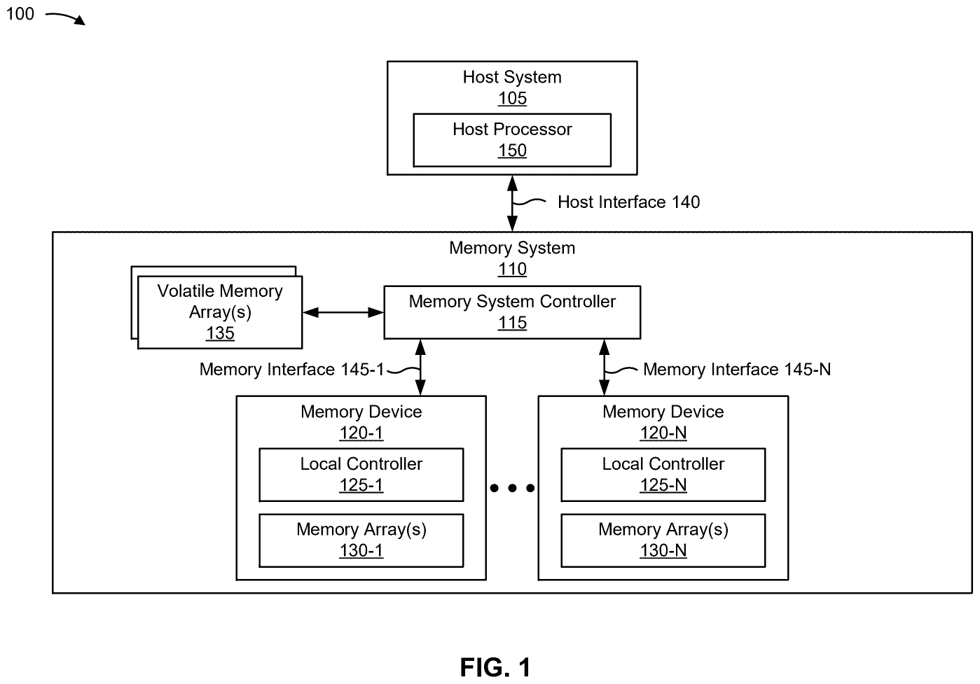

FIG. 1 is a diagram illustrating an example system 100 capable of a command address parity check using repurposing. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

The components of the system 100 may exchange information with the memory system 110 using a plurality of channels. In some examples, the channels enable communications between the host system 105 and the memory system 110. Each channel may include one or more signal paths or transmission mediums (e.g., conductors) between terminals associated with the components of system 100. For example, a channel may include a first terminal including one or more pins or pads at the host system 105 and one or more pins or pads at the memory system 110. A pin or a pad may both be referred to herein as a “pin.” A pin may be an example of a conductive input or output point of a device of the system 100, and a pin may be configured to act as part of a channel. The memory system 110, or one or more of its components (e.g., a memory device 120), may include a plurality of pins associated with the plurality of channels.

In some cases, a pin of a terminal may be part of a signal path of the channel. Additional signal paths may be coupled with a terminal of a channel for routing signals within a component of the system 100. For example, the memory system 110 may include signal paths (e.g., signal paths internal to the memory system 110 or its components, such as internal to a memory device 120) that route a signal from a terminal of a channel to the various components of the memory system 110 (e.g., the memory system controller 115, a memory device 120, a local controller 125, or a memory array 130).

Channels (and associated signal paths and terminals) may be dedicated to communicating specific types of information. In some cases, a channel may be an aggregated channel and thus may include multiple individual channels. For example, a data channel may be ×4 (e.g., including four signal paths), ×8 (e.g., including eight signal paths), ×16 (including sixteen signal paths), and so forth. Signals communicated over the channels may use DDR signaling. For example, some symbols of a signal may be registered on a rising edge of a clock signal and other symbols of the signal may be registered on a falling edge of the clock signal. Signals communicated over channels may use single data rate (SDR) signaling. For example, one symbol of the signal may be registered for each clock cycle.

In some cases, the channels may include one or more CA channels. The CA channels may be configured to communicate commands between the host system 105 and the memory system 110 including control information associated with the commands (e.g., address information). For example, the CA channel may include a read command with an address of the desired data. In some cases, the CA channels may be registered on a rising clock signal edge and/or a falling clock signal edge. In some cases, a CA channel may include any quantity of signal paths to decode address and command data (e.g., eight or nine signal paths). The memory system 110, or one of its components (e.g., a memory device 120), may include one or more (e.g., multiple) CA pins associated with the one or more CA channels.

In some cases, the channels may include one or more clock signal (CK) channels. The CK channels may be configured to communicate one or more common clock signals between the host system 105 and the memory system 110. Each clock signal may be configured to oscillate between a high state and a low state and coordinate the actions of the host system 105 and the memory system 110. In some cases, the clock signal may be a differential output (e.g., a CK_t signal and a CK_c signal) and the signal paths of the CK channels may be configured accordingly. In some cases, the clock signal may be single ended. A CK channel may include any quantity of signal paths. In some cases, the clock signal CK (e.g., a CK_t signal and a CK_c signal) may provide a timing reference for command and addressing operations for the memory system 110, or other system-wide operations for the memory system 110. The clock signal CK therefore may be variously referred to as a control clock signal CK, a command clock signal CK, or a system clock signal CK. The system clock signal CK may be generated by a system clock, which may include one or more hardware components (e.g., oscillators, crystals, logic gates, transistors, or the like). The memory system 110, or one of its components (e.g., a memory device 120), may include one or more (e.g., multiple) CK pins associated with the one or more CK channels.

In some cases, the channels may include one or more data (DQ) channels. The data channels may be configured to communicate data and/or control information between the host system 105 and the memory system 110. For example, the data channels may communicate information (e.g., bi-directional) to be written to the memory system 110 or information read from the memory system 110. The memory system 110, or one or more of its components (e.g., a memory device 120), may include one or more (e.g., multiple) data pins associated with the one or more data channels.

In some cases, the channels may include one or more other channels that may be dedicated to other purposes. These other channels may include any quantity of signal paths. The memory system 110, or one of its components (e.g., a memory device 120), may include one or more (e.g., multiple) pins associated with the one or more other channels. In some cases, the other channels may include one or more write clock signal (WCK) channels. While the ‘W’ in WCK may nominally stand for “write,” a write clock signal WCK (e.g., a WCK_t signal and a WCK_c signal) may provide a timing reference for access operations generally for the memory system 110 (e.g., a timing reference for both read and write operations). Accordingly, the write clock signal WCK may also be referred to as a data clock signal WCK. The WCK channels may be configured to communicate a common data clock signal between the host system 105 and the memory system 110. The data clock signal may be configured to coordinate an access operation (e.g., a write operation or read operation) of the host system 105 and the memory system 110. In some cases, the write clock signal may be a differential output (e.g., a WCK_t signal and a WCK_c signal) and the signal paths of the WCK channels may be configured accordingly. A WCK channel may include any quantity of signal paths. The data clock signal WCK may be generated by a data clock, which may include one or more hardware components (e.g., oscillators, crystals, logic gates, transistors, or the like).

In some implementations, one or more systems, devices, apparatuses, components, and/or controllers of FIG. 1 may be configured to receive, via a set of command pins, a set of command bits that indicates a command, where one or more bits of the set of command bits are repurposed as parity bits relating to remaining bits of the set of command bits; and perform a parity check using the one or more bits that are repurposed as parity bits.

In some implementations, one or more systems, devices, apparatuses, components, and/or controllers of FIG. 1 may be configured to receive a mode register command that configures a parameter in a mode register; receive a set of command bits that indicates a command, where configuration of the parameter in the mode register frees a switchable parameter bit, of the set of command bits, that otherwise is used to configure the parameter, and where the switchable parameter bit is used as a parity bit relating to remaining bits of the set of command bits; and perform a parity check using the switchable parameter bit that is used as the parity bit.

In some implementations, one or more systems, devices, apparatuses, components, and/or controllers of FIG. 1 may be configured to: transmit a set of command bits that indicates a command, where one or more bits of the set of command bits are repurposed as parity bits relating to remaining bits of the set of command bits. In some implementations, one or more systems, devices, apparatuses, components, and/or controllers of FIG. 1 may be configured to: receive the set of command bits; and perform a parity check using the one or more bits that are repurposed as parity bits.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

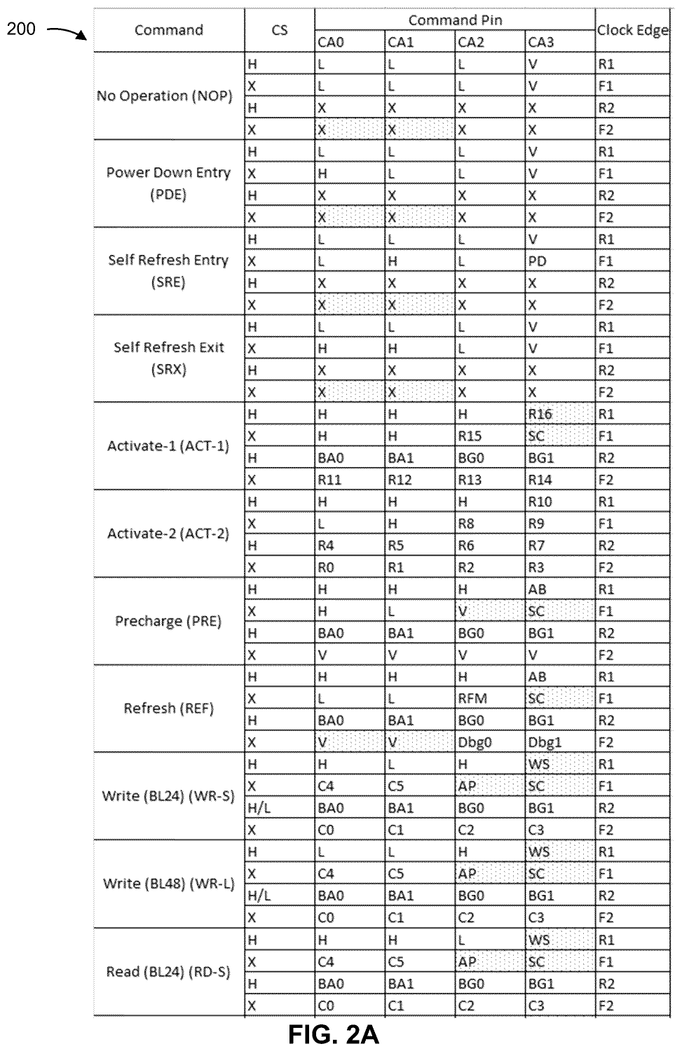

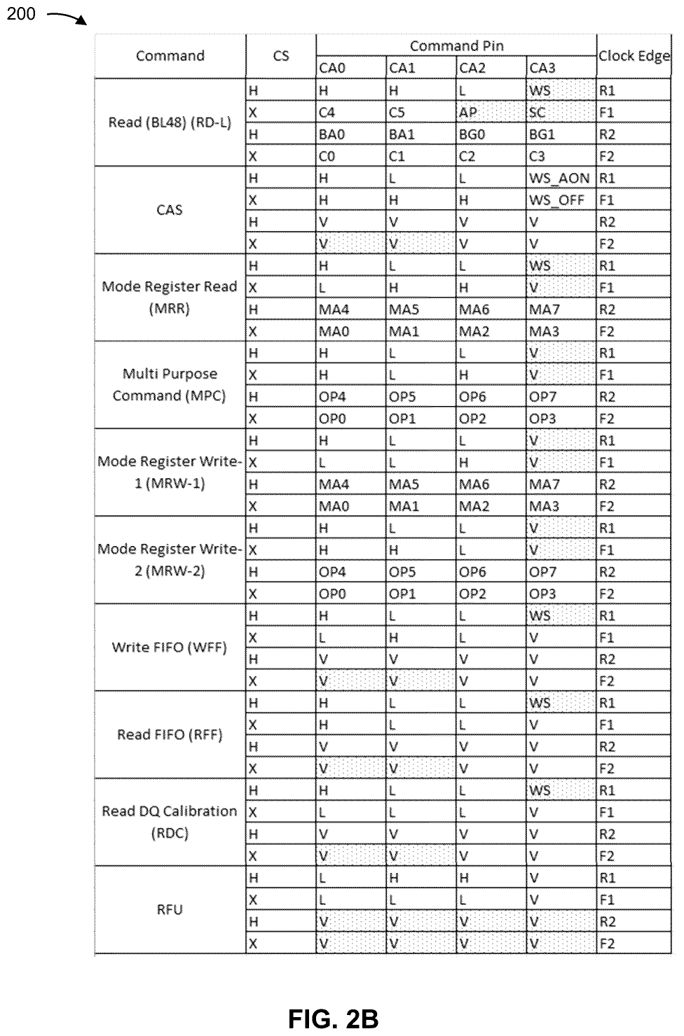

FIGS. 2A-2B show a table 200 indicating command definitions for memory. For example, the command definitions may relate to LP DDR commands for the memory system 110 or a component thereof. The table 200 indicates the signals for a chip select (CS) pin and four command pins (labeled CA0, CA1, CA2, and CA3), at a first rising edge (R1), a first falling edge (F1), a second rising edge (R2), and a second falling edge (F2) of a clock signal (e.g., DDR signaling), that can be used to indicate various commands. In table 200, “H” denotes a high signal and “L” denotes a low signal.

As shown, using DDR signaling, each command definition at the command pins may be represented by 16 bits of data. In some implementations, a command definition may be represented by a different number of bits. A command definition for a command may indicate one or more available bits (e.g., RFU bits), which are shown as a “V” or an “X” in table 200. Additionally, or alternatively, a command definition for a command may indicate one or more switchable parameter bits. “Switchable parameter bit” may refer to a bit that can be used to switch a setting for a parameter in connection with sending of a command. A switchable parameter may include a clock synchronization parameter (associated with a “WS” bit in table 200), an efficiency mode parameter (associated with an “SC” bit in table 200), and/or an auto precharge parameter (associated with an “AP” bit in table 200), among other examples. Shaded bits in table 200 indicate available bits and/or switchable parameter bits that can be repurposed as parity bits for the commands of table 200. In some implementations, the commands may be defined such that bit locations of the available bits and/or switchable parameter bits that can be repurposed as parity bits are in the same locations across all commands.

As indicated above, FIGS. 2A-2B are provided as an example. Other examples may differ from what is described with regard to FIGS. 2A-2B.

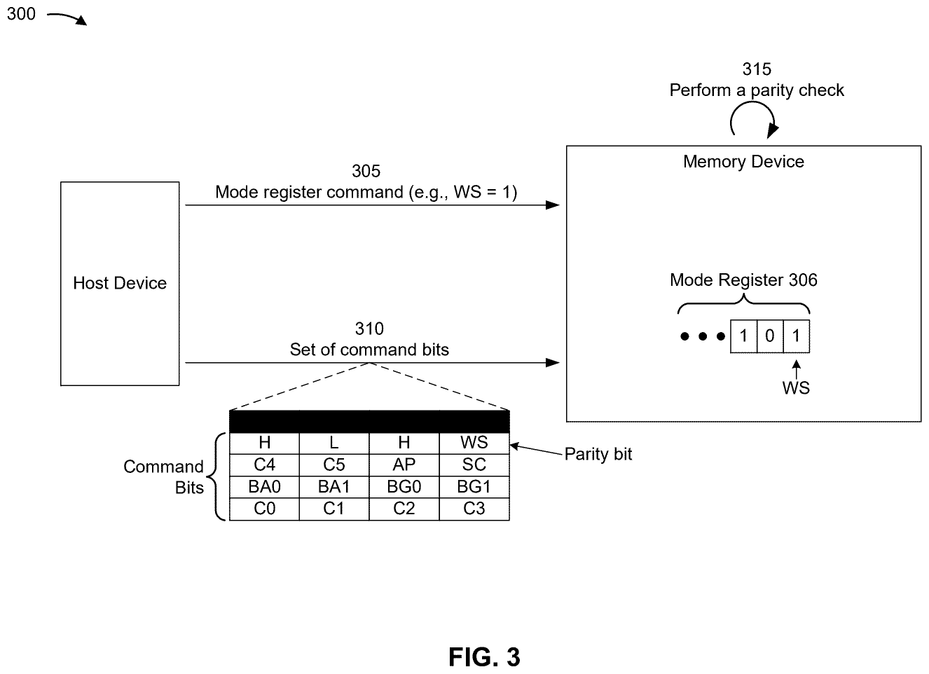

FIG. 3 is a diagram of an example 300 of a command address parity check using repurposing. Various operations described in connection with FIG. 3 may be performed by a memory device, such as the memory system 110 and/or one or more components of the memory system 110, including the memory system controller 115, one or more memory devices 120, and/or one or more local controllers 125. As described herein, the memory device may have a plurality of pins, including a set of command pins (also referred to herein as “CA pins”) used for communicating commands between a host device (e.g., host system 105 or host processor 150) and the memory device.

As shown by reference number 305, the host device may transmit, and the memory device may receive, a mode register command for a mode register 306 of the memory device. The mode register command may configure (e.g., set) a parameter (e.g., a clock synchronization parameter, an efficiency mode parameter, and/or an auto precharge parameter) in the mode register 306. The parameter may also be configured through a switchable parameter bit of a memory command, as described in connection with FIGS. 2A-2B. However, configuration of the parameter in the mode register 306 frees the switchable parameter bit, that otherwise would be used to configure the parameter, for use as a parity bit.

As an example, a mode register bit may be set to indicate that clock synchronization (e.g., WCK2CK SYNC ON) is always on or always off, thereby disabling selectable clock synchronization and freeing a WS bit of a command for use in CA parity. As another example, a mode register bit may be set to indicate that an efficiency mode is always on or always off, thereby disabling efficiency mode selection and freeing an SC bit of a command for use in CA parity. As a further example, a mode register bit may be set to indicate that auto precharge is always on or always off, thereby disabling selectable auto precharge and freeing an AP bit of a command for use in CA parity.

Thus, three (or more) switchable parameter bits may be freed for use in CA parity by enabling configuration of their associated parameters in the mode register 306. In some implementations, which and how many of the switchable parameter bits that are freed may be in accordance with a user selection (e.g., by a user of the memory device). For example, the memory device may be configured in accordance with the user selection. The user selection may be based on a desired DC level.

As shown by reference number 310, the host device may transmit, and the memory device may receive (e.g., by DDR signaling), a set of command bits. For example, the memory device may receive the set of command bits via the set of command pins (e.g., the memory device may receive signaling indicating the command bits via the set of command pins). The set of command bits may indicate a command, such as one of the commands defined in table 200. Moreover, the set of command bits may also indicate control information (e.g., address information) associated with the command. For example, the set of command bits may be represented as a data matrix indicating the command and the address information.

One or more of the command bits may be repurposed as parity bits that relate to remaining bits of the set of command bits (e.g., one or more of the command pins that are to convey the command data may also convey parity information). For example, the host device may compute a parity value based on the remaining bits, and the host device may transmit the parity value in a command bit that is repurposed as a parity bit. In some implementations, only a single bit of the command bits may be repurposed as a parity bit relating to all of the remaining bits of the set of command bits (e.g., for a command that is communicated using 16 command bits, one of the command bits may be repurposed as a parity bit relating to the remaining 15 bits). For example, the single bit may be used for parity on all remaining R1, F1, R2, and F2 bits for the command. In some implementations, a first bit of the command bits may be repurposed as a first parity bit relating to a first portion of the remaining bits of the set of command bits, and a second bit of the command bits may be repurposed as a second parity bit relating to a second portion of the remaining bits (e.g., for a command that is communicated using 16 command bits, two of the command bits may be repurposed as parity bits relating to respective portions of the remaining 14 bits). For example, the first bit may be used for parity on all remaining R1 and F1 bits for the command, and the second bit may be used for parity on all remaining R2 and F2 bits for the command. In some implementations, more than two bits of the command bits (e.g., three bits or four bits) may be used for parity on multiple respective portions of remaining bits for the command, in a similar manner as described above.

In some implementations, a definition of the command (e.g., in accordance with table 200) may indicate two RFU bits (available bits) for the command. Accordingly, the command bits that are repurposed as parity bits may include the two RFU bits. In some implementations, a definition of the command (e.g., in accordance with table 200) may indicate one RFU bit (available bit) and one switchable parameter bit (e.g., a switchable parameter bit that has been freed through configuration in the mode register 306, as described herein) for the command. Accordingly, the command bits that are repurposed as parity bits may include the one RFU bit and the one switchable parameter bit. In some implementations, a definition of the command (e.g., in accordance with table 200) may indicate zero RFU bits and two switchable parameter bits (e.g., switchable parameter bits that have been freed through configuration in the mode register 306, as described herein) for the command. Accordingly, the command bits that are repurposed as parity bits may include the two switchable parameter bits.

In some implementations, prior to or following communication of the set of command bits, the host device may transmit, and the memory device may receive, via the set of command pins, an additional set of command bits that indicate a different command, in a similar manner as described in connection with reference number 310. In some implementations, a definition of the different command may indicate zero RFU bits and zero switchable parameter bits (e.g., there are no bits that can be repurposed as parity bits for the different command). Accordingly, the command bits, of the original set of command bits, that are repurposed as parity bits may relate to the remaining bits of the original set of command bits and may relate to the additional set of command bits (e.g., for a first command and a second command that are each communicated using 16 command bits, one of the command bits for the first command may be repurposed as a parity bit relating to the remaining 15 bits for the first command and all 16 bits of the second command).

In some examples, the command may be an activate-1 (ACT-1) command (e.g., a command to activate a row or bank in memory) and the different command may be an activate-2 (ACT-2) command (e.g., a command to deactivate a previously activated row or bank before activating a new one). For example, parity for the ACT-1 command and the ACT-2 command may be combined in one or more command bits for the ACT-1 command that have been repurposed as parity bits. In some implementations, one switchable parameter bit (e.g., an SC bit) of the command bits for the ACT-1 command may be repurposed as a parity bit relating to the remainder of the command bits for the ACT-1 command and all of the command bits for the ACT-2 command. In some implementations, a first switchable parameter bit (e.g., an SC bit) of the command bits for the ACT-1 command may be repurposed as a parity bit relating to the remaining command bits for the ACT-1 command, and a second switchable parameter bit (e.g., an R16 bit, shown in table 200) of the command bits for the ACT-1 command may be repurposed as a parity bit relating to the command bits for the ACT-2 command.

In some implementations, a definition of the command (e.g., in accordance with table 200) may indicate multiple column address bits (labeled as C0, C1, C2, and C3 in table 200) that indicate address information for the command (e.g., for a read command or a write command). Accordingly, the command bits that are repurposed as parity bits may include one or more of the column address bits. For example, the one or more column address bits that are repurposed as parity bits may include a least significant bit for the column address (C0 in table 200) and/or a second least significant bit for the column address (C1 in table 200), thereby supporting up to two parity bits. For example, when reading or writing data in bursts (e.g., using a burst size of 32 bytes) using an alignment to a boundary (e.g., an 8-bit boundary), the least significant bit of the column address (C0) and the second least significant bit of the column address (C1) may remain constant across multiple reads or writes (e.g., C0 and C1 may have a constant “0” value). Accordingly, the least significant bit of the column address (C0) and the second least significant bit of the column address (C1) can be assumed to have their constant values (e.g., these bits could be defined as “don't care” bits), thereby freeing these bits for use as parity bits. In some implementations, the one or more column address bits that are repurposed as parity bits may additionally include a third least significant bit of the column address (C2 in table 200) and/or a most significant bit of the column address (C3 in table 200), thereby supporting up to four parity bits.

If C0 is blocked and repurposed for parity, then the last two column addresses are blocked and data is bounded by 32 bits or 4 bytes, thereby providing 50% DC. If C0 and C1 are blocked and repurposed for parity, then the last four column addresses are blocked and data is bounded by 64 bits or 8 bytes, thereby providing 78.6% DC. If C0, C1, and C2 are blocked and repurposed for parity, then the last eight column addresses are blocked and data is bounded by 128 bits or 16 bytes, thereby providing 93.8% DC. If C0, C1, C2, and C3 are blocked and repurposed for parity, then the last sixteen column addresses are blocked and data is bounded by 256 bits or 32 bytes, thereby providing 99.6% DC.

In some implementations, CS bits may be repurposed as parity bits in connection with the command. For example, a CS input during a second rising edge of a clock signal (R2) may be kept (e.g., may remain) at a high level, and one or both CS states during falling edges of a clock signal (F1, F2) may be used for parity information. As another example, a CS input during a first rising edge of a clock signal (R1) and at a first falling edge of the clock signal (F1) may be required at a high level, and a CS high state during a second rising edge of the clock signal (R2) and at a second falling edge of the clock signal (F2) may be used for parity information.

As shown by reference number 315, the memory device may perform a parity check using the bit(s) of the set of command bits that have been repurposed as parity bit(s). For example, the memory device may compute a parity value for the remaining bits (or a portion thereof) of the set of command bits (e.g., using an XOR operation on the remaining bits), and the memory device may perform the parity check by comparing the parity value to a value of a parity bit. The memory device may perform the parity check in connection with executing a memory operation in accordance with the command. For example, the memory device may execute the memory operation provided that the parity check succeeds (e.g., the computed parity value matches the parity bit). Alternatively, if the parity check fails, the memory device may refrain from executing the memory operation, may register an indication of the failed parity check, and/or may transmit an indication of the failed parity check to the host device.

In this way, techniques described herein enable CA parity checks through repurposing of command bits and without introducing dedicated CA parity pins. Techniques described herein may enable one repurposed parity bit providing 50% DC, two repurposed parity bits providing 78.6% DC, three repurposed parity bits providing 86% DC, or four repurposed parity bits providing 93.8% DC. Accordingly, techniques described herein bolster error detection capabilities of the memory device and sustain data integrity at higher data rates.

As indicated above, FIG. 3 is provided as an example. Other examples may differ from what is described with regard to FIG. 3.

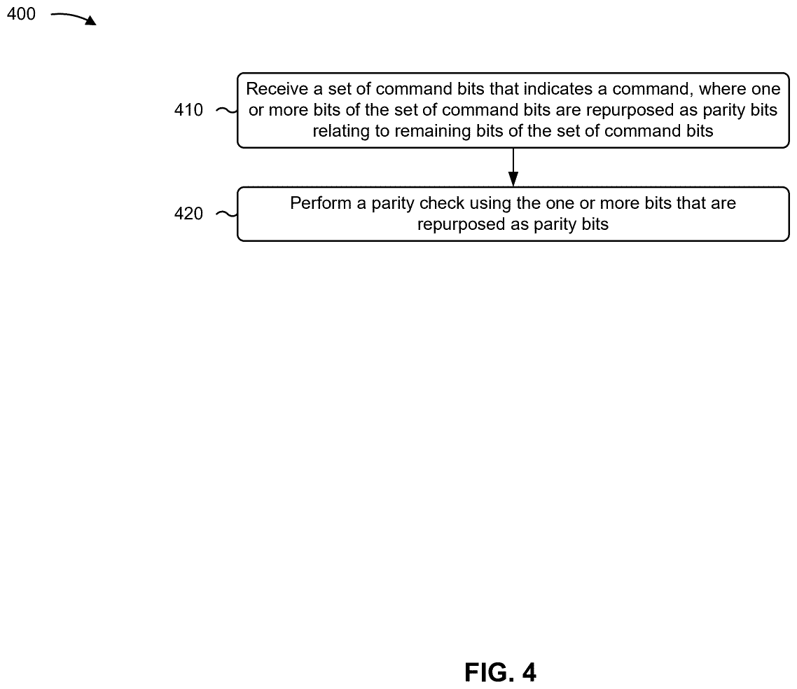

FIG. 4 is a flowchart of an example method 400 associated with a command address parity check using repurposing. In some implementations, a memory device (e.g., the memory system 110) may perform or may be configured to perform the method 400. In some implementations, another device or a group of devices separate from or including the memory device may perform or may be configured to perform the method 400. Additionally, or alternatively, one or more components of the memory device (e.g., the memory system controller 115, the memory device 120, the local controller 125, or the memory array 130) may perform or may be configured to perform the method 400. Thus, means for performing the method 400 may include the memory device and/or one or more components of the memory device. Additionally, or alternatively, a non-transitory computer-readable medium may store one or more instructions that, when executed by the memory device (e.g., the memory system controller 115 and/or the local controller 125), cause the memory device to perform the method 400.

As shown in FIG. 4, the method 400 may include receiving a set of command bits that indicates a command, where one or more bits of the set of command bits are repurposed as parity bits relating to remaining bits of the set of command bits (block 410). As further shown in FIG. 4, the method 400 may include performing a parity check using the one or more bits that are repurposed as parity bits (block 420).

The method 400 may include additional aspects, such as any single aspect or any combination of aspects described below and/or described in connection with one or more other methods or operations described elsewhere herein.

In a first aspect, the set of command bits indicate the command and address information.

In a second aspect, alone or in combination with the first aspect, the one or more bits include only a single bit that is repurposed as a parity bit relating to all of the remaining bits.

In a third aspect, alone or in combination with one or more of the first and second aspects, the one or more bits include a first bit that is repurposed as a first parity bit relating to a first portion of the remaining bits, and a second bit that is repurposed as a second parity bit relating to a second portion of the remaining bits.

In a fourth aspect, alone or in combination with one or more of the first through third aspects, a definition of the command indicates two RFU bits for the command, and the one or more bits, that are repurposed as parity bits, include the two RFU bits.

In a fifth aspect, alone or in combination with one or more of the first through fourth aspects, a definition of the command indicates one RFU bit and one switchable parameter bit for the command, and the one or more bits, that are repurposed as parity bits, include the one RFU bit and the one switchable parameter bit.

In a sixth aspect, alone or in combination with one or more of the first through fifth aspects, a definition of the command indicates zero RFU bits and two switchable parameter bits for the command, and the one or more bits, that are repurposed as parity bits, include the two switchable parameter bits.

In a seventh aspect, alone or in combination with one or more of the first through sixth aspects, the method 400 includes receiving an additional set of command bits that indicate a different command, where a definition of the different command indicates zero RFU bits and zero switchable parameter bits for the different command, and the one or more bits are repurposed as parity bits relating to the remaining bits of the set of command bits, and relating to the additional set of command bits.

In an eighth aspect, alone or in combination with one or more of the first through seventh aspects, a definition of the command indicates a switchable parameter bit for the command, and a parameter indicated by the switchable parameter bit is configured in a mode register to free the switchable parameter bit for use as a parity bit.

In a ninth aspect, alone or in combination with one or more of the first through eighth aspects, the parameter is a clock synchronization parameter, an efficiency mode parameter, or an auto precharge parameter.

In a tenth aspect, alone or in combination with one or more of the first through ninth aspects, a definition of the command indicates multiple column address bits that indicate address information for the command, and the one or more bits, that are repurposed as parity bits, include one or more of the multiple column address bits.

In an eleventh aspect, alone or in combination with one or more of the first through tenth aspects, receiving the set of command bits includes receiving the set of command bits by DDR signaling.

In a twelfth aspect, alone or in combination with one or more of the first through eleventh aspects, the memory device includes DRAM.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

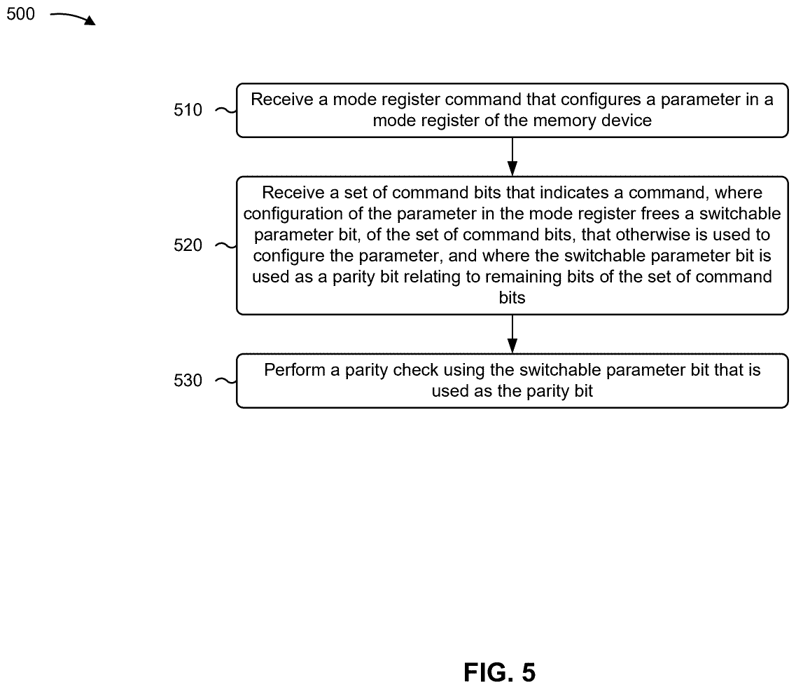

FIG. 5 is a flowchart of an example method 500 associated with a command address parity check using repurposing. In some implementations, a memory device (e.g., the memory system 110) may perform or may be configured to perform the method 500. In some implementations, another device or a group of devices separate from or including the memory device may perform or may be configured to perform the method 500. Additionally, or alternatively, one or more components of the memory device (e.g., the memory system controller 115, the memory device 120, the local controller 125, or the memory array 130) may perform or may be configured to perform the method 500. Thus, means for performing the method 500 may include the memory device and/or one or more components of the memory device. Additionally, or alternatively, a non-transitory computer-readable medium may store one or more instructions that, when executed by the memory device (e.g., the memory system controller 115 and/or the local controller 125), cause the memory device to perform the method 500.

As shown in FIG. 5, the method 500 may include receiving a mode register command that configures a parameter in a mode register of a memory device (block 510). As further shown in FIG. 5, the method 500 may include receiving a set of command bits that indicates a command, where configuration of the parameter in the mode register frees a switchable parameter bit, of the set of command bits, that otherwise is used to configure the parameter, and where the switchable parameter bit is used as a parity bit relating to remaining bits of the set of command bits (block 520). As further shown in FIG. 5, the method 500 may include performing a parity check using the switchable parameter bit that is used as the parity bit (block 530).

The method 500 may include additional aspects, such as any single aspect or any combination of aspects described below and/or described in connection with one or more other methods or operations described elsewhere herein.

In a first aspect, the switchable parameter bit is used as a parity bit relating to all of the remaining bits.

In a second aspect, alone or in combination with the first aspect, the switchable parameter bit is a first switchable parameter bit, and the set of command bits further includes a second switchable parameter bit that is freed through configuration in the mode register, and the first switchable parameter bit is used as a first parity bit relating to a first portion of the remaining bits, and the second switchable parameter bit is used as a second parity bit relating to a second portion of the remaining bits.

In a third aspect, alone or in combination with one or more of the first and second aspects, the set of command bits further includes an RFU bit, and the switchable parameter bit is used as a first parity bit relating to a first portion of the remaining bits, and the RFU bit is used as a second parity bit relating to a second portion of the remaining bits.

In a fourth aspect, alone or in combination with one or more of the first through third aspects, the parameter is a clock synchronization parameter, an efficiency mode parameter, or an auto precharge parameter.

In a fifth aspect, alone or in combination with one or more of the first through fourth aspects, the set of command bits are received by DDR signaling.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a memory device includes a plurality of pins including a set of command pins; and one or more components configured to: receive, via the set of command pins, a set of command bits that indicates a command, where one or more bits of the set of command bits are repurposed as parity bits relating to remaining bits of the set of command bits; and perform a parity check using the one or more bits that are repurposed as parity bits.

In some implementations, a method includes receiving, by a memory device, a mode register command that configures a parameter in a mode register of the memory device; receiving, by the memory device via a set of command pins, a set of command bits that indicates a command, where configuration of the parameter in the mode register frees a switchable parameter bit, of the set of command bits, that otherwise is used to configure the parameter, and where the switchable parameter bit is used as a parity bit relating to remaining bits of the set of command bits; and performing, by the memory device, a parity check using the switchable parameter bit that is used as the parity bit.

In some implementations, a system includes a host device configured to: transmit a set of command bits that indicates a command, where one or more bits of the set of command bits are repurposed as parity bits relating to remaining bits of the set of command bits; and a memory device configured to: receive the set of command bits; and perform a parity check using the one or more bits that are repurposed as parity bits.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
a plurality of pins including a set of command pins; and
one or more components configured to:
receive, via the set of command pins, a set of command bits that indicates a command,
wherein one or more bits of the set of command bits are repurposed as parity bits relating to remaining bits of the set of command bits; and
perform a parity check using the one or more bits that are repurposed as parity bits.

2. The memory device of claim 1, wherein the set of command bits indicate the command and address information.

3. The memory device of claim 1, wherein the one or more bits comprise only a single bit that is repurposed as a parity bit relating to all of the remaining bits.

4. The memory device of claim 1, wherein the one or more bits comprise a first bit that is repurposed as a first parity bit relating to a first portion of the remaining bits, and a second bit that is repurposed as a second parity bit relating to a second portion of the remaining bits.

5. The memory device of claim 1, wherein a definition of the command indicates two reserved for future use (RFU) bits for the command, and
wherein the one or more bits, that are repurposed as parity bits, comprise the two RFU bits.

6. The memory device of claim 1, wherein a definition of the command indicates one reserved for future use (RFU) bit and one switchable parameter bit for the command, and
wherein the one or more bits, that are repurposed as parity bits, comprise the one RFU bit and the one switchable parameter bit.

7. The memory device of claim 1, wherein a definition of the command indicates zero reserved for future use (RFU) bits and two switchable parameter bits for the command, and
wherein the one or more bits, that are repurposed as parity bits, comprise the two switchable parameter bits.

8. The memory device of claim 1, wherein the one or more components are further configured to receive, via the set of command pins, an additional set of command bits that indicate a different command,
wherein a definition of the different command indicates zero reserved for future use (RFU) bits and zero switchable parameter bits for the different command, and
wherein the one or more bits are repurposed as parity bits relating to the remaining bits of the set of command bits, and relating to the additional set of command bits.

9. The memory device of claim 1, wherein a definition of the command indicates a switchable parameter bit for the command, and
wherein a parameter indicated by the switchable parameter bit is configured in a mode register to free the switchable parameter bit for use as a parity bit.

10. The memory device of claim 9, wherein the parameter is a clock synchronization parameter, an efficiency mode parameter, or an auto precharge parameter.

11. The memory device of claim 1, wherein a definition of the command indicates multiple column address bits that indicate address information for the command, and
wherein the one or more bits, that are repurposed as parity bits, comprise one or more of the multiple column address bits.

12. The memory device of claim 1, wherein the one or more components, to receive the set of command bits, are configured to receive the set of command bits by double data rate (DDR) signaling.

13. The memory device of claim 1, wherein the memory device comprises dynamic random-access memory (DRAM).

14. A method, comprising:
receiving, by a memory device, a mode register command that configures a parameter in a mode register of the memory device;
receiving, by the memory device via a set of command pins, a set of command bits that indicates a command,
wherein configuration of the parameter in the mode register frees a switchable parameter bit, of the set of command bits, that otherwise is used to configure the parameter, and
wherein the switchable parameter bit is used as a parity bit relating to remaining bits of the set of command bits; and
performing, by the memory device, a parity check using the switchable parameter bit that is used as the parity bit.

15. The method of claim 14, wherein the switchable parameter bit is used as a parity bit relating to all of the remaining bits.

16. The method of claim 14, wherein the switchable parameter bit is a first switchable parameter bit, and the set of command bits further comprises a second switchable parameter bit that is freed through configuration in the mode register, and
wherein the first switchable parameter bit is used as a first parity bit relating to a first portion of the remaining bits, and the second switchable parameter bit is used as a second parity bit relating to a second portion of the remaining bits.

17. The method of claim 14, wherein the set of command bits further comprises a reserved for future use (RFU) bit, and
wherein the switchable parameter bit is used as a first parity bit relating to a first portion of the remaining bits, and the RFU bit is used as a second parity bit relating to a second portion of the remaining bits.

18. The method of claim 14, wherein the parameter is a clock synchronization parameter, an efficiency mode parameter, or an auto precharge parameter.

19. The method of claim 14, wherein the set of command bits are received by double data rate (DDR) signaling.

20. A system, comprising:
a host device configured to:
transmit a set of command bits that indicates a command,
wherein one or more bits of the set of command bits are repurposed as parity bits relating to remaining bits of the set of command bits; and
a memory device configured to:
receive the set of command bits; and
perform a parity check using the one or more bits that are repurposed as parity bits.

21. The system of claim 20, wherein a definition of the command indicates two reserved for future use (RFU) bits for the command, and
wherein the one or more bits, that are repurposed as parity bits, comprise the two RFU bits.

22. The system of claim 20, wherein a definition of the command indicates one reserved for future use (RFU) bit and one switchable parameter bit for the command, and
wherein the one or more bits, that are repurposed as parity bits, comprise the one RFU bit and the one switchable parameter bit.

23. The system of claim 20, wherein a definition of the command indicates zero reserved for future use (RFU) bits and two switchable parameter bits for the command, and
wherein the one or more bits, that are repurposed as parity bits, comprise the two switchable parameter bits.

24. The system of claim 20, wherein a definition of the command indicates a switchable parameter bit for the command, and
wherein a parameter indicated by the switchable parameter bit is configured in a mode register to free the switchable parameter bit for use as a parity bit.

25. The system of claim 24, wherein the parameter is a clock synchronization parameter, an efficiency mode parameter, or an auto precharge parameter.
